(19) United States
(12) Patent Application Publication
(10) Pub. No.: US 2026/0167791 A1
(43) Pub. Date: Jun. 18, 2026

(54) POLYAMIDE FOAMS WITH HIGH THERMAL STABILITY

(71) Applicant: BASE SE, Ludwigshafen am Rhein (DE)

(72) Inventors: Patrick Spies, Ludwigshafen am Rhein (DE); Daniela LONGO-SCHEDEL, Ludwigshafen am Rhein (DE); Angelika KELLER, Ludwigshafen am Rhein (DE); Jens CREMER, Ludwigshafen am Rhein (DE)

(21) Appl. No.: 19/123,527

(22) PCT Filed: Oct. 20, 2023
(86) PCT No.: PCT/EP2023/079243

§ 371 Date: Apr. 23, 2025

(30) Foreign Application Priority Data
Oct. 25, 2022 (EP) 22203530.5

(51) Int. Cl. C08J 9/00; C08J 9/12; C08J 9/18; C08J 9/232

(52) U.S. Cl. CPC C08J 9/0028; C08J 9/122; C08J 9/18; C08J 9/232; C08J 2203/06; C08J 2377/06

(57) ABSTRACT

The present invention relates to polyamide foam particles comprising
(A) from 5 to 99.9 wt.-% of at least one polyamide,
(B) from 0.1 to 5 wt.-% of at least one stabilizer, selected from secondary arylamines
(C) from 0 to 49 wt.-% of further additives,
wherein the sum of the components (A) to (C) is 100 wt.-%, a process for preparing the polyamide foam particles and polyamide particle foam moldings made therefrom.

The present invention relates to polyamide foam particles comprising
(A) from 5 to 99.9 wt.-% of at least one polyamide,
(B) from 0.1 to 5 wt.-% of at least one stabilizer, selected from the group of secondary aryl amines,
(C) from 0 to 49 wt.-% of further additives,
wherein the sum of the components (A) to (C) is 100 wt.-%, a process for preparing the polyamide foam particles and polyamide particle foam moldings made therefrom.

### RELEVANT PRIOR ART

Particle foams based on polyamide are well known in the literature. First PA particle foams have been publishing in the 1980 (JP61-268737). In recent publication polyamide particle foams are described, which are free of organic blowing agents, and which can be processed with established steam technology (WO2021/052881 A1; WO2016/147582A1; US20210253819_A1). Since most partial crystalline polyamides, like PA6; PA66 and PA6/66 have good mechanical properties, even at temperatures above 150° C., it would be beneficial to use parts made from polyamide particle foams at temperatures above 150° C. use temperature.

Due to the fact that a molded part from a polymeric particle foam has a relatively high contact area with the surrounding air inside the cells and in the interspace between the fused beads, such a molded part is highly sensitive for thermal oxidative ageing processes. The established antioxidation agents for polyamide have an impact on the processing properties in the steam chest molding process. Although the most effective antioxidation agents contain halogens like bromine and iodine which are critical for application due to the corrosive effect of halogens beside metals and electronic devices and the formation of poisonous flue gases in case of a fire. Halogen based heat stabilizers like potassium iodine in combination with copper (I) iodide are critical regarding Global Health System GHS classification.

US 2018/0044497 discloses a polyamide resin foam shaped product containing a polyamide resin and having a crystallinity X of 10% to 50% and a crystallite size D of 10 nm or more as calculated based on a peak having a smallest peak width in an X-ray diffraction profile of the foam shaped product, and a method of producing this polyamide resin foam shaped product.

US 2021/0253819 A1 disclose polyamide-based resin expanded beads having a crystallite size of more than 8 nm as measured by X-ray diffraction method.

WO 2011/134996 A1 relates to expandable granules, containing a polymer matrix consisting of at least 55 wt % of polyamides having crystallinity of up to 30%, which are suitable for producing a particulate foam for use in the automotive industry, aviation industry, building industry, packaging industry, sports and recreation industry, in transportation and/or in construction. The granules may contain heat stabilizers or antioxidants selected from the group of copper compounds, sterically hindered phenols, sterically hindered aliphatic amines and/or aromatic amines.

These well-known inorganic stabilizers which can contains cupper iodide, bromide, chloride in combination with an alkaline halogenide, have a negative impact on the processability on the foaming process. Besides inorganic stabilizers also sterically hindered phenols are well known heat stabilizers for polyamide, but the long-time stabilizing effect is limited to temperatures up to 120° C.

WO 2021/052881 A1 discloses polyamide foam particles obtainable with low bulk densities by a continuous one-step process and polyamide particle foam moldings obtainable by steam-chest molding with high temperature stability which particularly are suitable to pass high temperature conditions like an electrodeposition coating process.

US 2022/0169849 A1 is directed to provide polyamide-based resin pre-expanded particles which can serve as a raw material of a polyamide-based resin foam shaped product having an excellent mechanical strength. Polyamide-based resin pre-expanded particles of the present disclosure contain a polyamide-based resin. The polyamide-based resin pre-expanded particles have an expansion ratio of 1.0 or more, wherein the expansion ratio is a ratio (p1/p2) of a density p1 (g/cm3) to a density p2 (g/cm3) after being pressurized with air at 0.9 MPa and then heated for 30 seconds with saturated steam at a temperature higher than a thermal fusion temperature by 5° C.

U.S. Pat. No. 5,399,681 B1 discloses a colored thermoplastic resin composition comprising a crystalline thermoplastic resin containing a black dye or a black dye and a fibrous reinforcing material i. e. fiber-reinforced polyamide, wherein said black dye is a black dye obtainable by a reaction of one or more anionic surfactants and nigrosine. The black die has excellent dispersibility and compatibility with the crystalline thermoplastic resin and lowers the crystallizing temperature to produce molded products with excellent appearance and high surface gloss.

WO 2021/191209 discloses a heat-aging resistant polyamide molding compositions, comprising at least one thermoplastic polyamide and a specific combination of at least one polyethylenimine homo- or copolymer with at least one secondary aryl amine and at least one condensation product of secondary aryl amines and aliphatic aldehydes, aliphatic ketones, or mixtures thereof.

US 2020/317878 discloses a continuous method of producing polyamide foams with a smooth surface, low density, and small cell size by an extrusion foaming process including a polyamide resin compounded with a composite epoxy chain and a maleic anhydride grafted polypropylene (MAPP) wax.

### SUMMARY OF THE INVENTION

The present invention was made in view of the prior art described above, and the object of the present invention was to provide halogen-free polyamide foam particles, which are processable on standard steam chest molding equipment to polyamide particle foam moldings with a high closed-cell ratio and high thermal oxidative stability at high temperatures and high humidity.

The problem was solved by polyamide foam particles comprising
(A) from 5 to 99.9 wt.-% of at least one polyamide,
(B) from 0.1 to 5 wt.-% of at least one stabilizer, selected from secondary aryl amines
(C) from 0 to 49 wt.-% of further additives,
   wherein the sum of the components (A) to (C) is 100 wt.-%.

Preferably the polyamide foam particles consist of
(A) from 84.5 to 99.5 wt.-% of at least one polyamide,
(B) from 0.5 to 3 wt.-% of at least one stabilizer, selected from secondary aryl amines
(C) from 0 to 15 wt.-% of further additives,
   wherein the sum of the components (A) to (C) is 100 wt.-%.

In case of mixtures the weight percent given for (A), (B) and (C) refers to the sum of all polyamides, stabilizers or additives respectively.

The at least one polyamide may be a homopolyamide obtained from polymerization of lactams, such as caprolactames or lauryllactames, condensation products of diamines and dicarboxylic acids, copolyamides thereof or mixtures of two or more different polyamides

Preferably the at least one polyamide (A) is selected from partially crystalline polyamides having a melting point (peak melting temperature Tₚₘ) in the range from 150 to 350° C. determined by differential scanning calorimetry (DSC) according to DIN EN ISO 11357-3:2018.

Also particularly preferred are polyamides (A) having a crystallinity of more than 20%, preferably in the range from 25 to 60%, determined by means of differential scanning calorimetry (DSC) according to DIN EN ISO 11357_3_2018 by integration of the melting signal, i. a crystallinity of 100% corresponds to 230 J/g (Journal of Polymer Science Part B Polymer Physics 35 (1997) 2219-2231).

Preferably polyamide (A) comprises at least one polyamide selected from the group consisting of polycaprolactam (PA6), polybutylene adipamide (PA 4.6), polyhexamethylene adipamide (PA 6.6), polyhexamethylene sebacamide (PA 6.10), polyhexamethylene dodecanamide (PA 6.12), Poly-1 1-aminoundecanamide (PA 11), polylaurolactam (PA 12), poly-mxylylene adipamide (PAMXD 6), polypentamethylene sebacamide (PA 510), 6T/Z (Z=lactam), 6T/61, 6T/61/XY, 6T/XT (X=straight-chain or branched C4-C18-diamine), XT (X=C4-C18-diamine), 6.12. PA PACM 12 (PACM=p-diaminodicyclohexylmethane), PA MACM 12 (MACM=3,3-dimethyl-pdiaminodicyclohexylmethane), PA MPMD 6 (MPMD 2-methyl pentamethylene diamine), PA MPMD T, PA MPMD 12, polyhexamethylene isophthalamide (PA 61), polyhexamethylene isophthalamide cohexamethylene terephthalamid (PA 61/6T), PA 6-3-T (terephthalic acid polyamide and mixtures of 2,2,4- and 2,4,4-trimethylhexamethylenediamine), polybutylene sebacamide (PA 4.10), polydecamethylene sebacamide (PA 10.10), polypentamethylene adipamide (PA 5.6), PA 6/66 and PA 66/6, PA 6Y (Y=C4-C18-diacid) and their transamidation products

Most preferably the at least one polyamide (A) is selected from the group consisting of polycaprolatam (PA6), polylaurolactam (PA 12, polyhexamethylene adipamide (PA 6.6), poly-hexamethylene sebacamide (PA 6.10), polyhex-amethylene dodecanamide (PA 6.12), PA 6/66, PA 66/6 and copolyamide PA6/6.36 or mix-tures therefrom.

Preferably the bulk density of the polyamide foam particles is in the range from 100 to 500 kg/m³, preferably in the range from 250 to 350 kg/m³.

The at least one stabilizer (B) is selected from secondary arylamines. Mixtures of two or more different secondary amines may be used as stabilizer (B).

Compounds with the general structure R₁—NH-R₂ with R₁ and R₂ are aromatic moieties may be used as stabilizer (B).

Preferably the at least one stabilizer (B) is selected from
(B1) an amine-containing heat stabilizer comprising bis(4-(1-methyl-1-phenylethyl) phenyl) amine, 2-ethyl-2′-ethoy-oxal anilid, dimethyl glyoxime, 2,2′-bipyridine, 1,10-phenanthroline, ortho-phenylenediamine, 1,2-diaminocyclohexane, 1,4-diamino butane, urea, 8-hydroxy quinoline, substituted urea, and combinations thereof.
(B2) a nigrosine containing stabilizer, or
(B3) a stabilizer comprising adducts of phenylenediamine with acetone, adducts of phenylenediamine with linolenic acid, 4,4′-bis(α,α-dimethylbenzyl)diphenylamine, N,N′-dinaphthyl-p-phenylenediamine, N-phenyl-N′-cyclohexyl-p-phenylenediamine,
   or mixtures of two or more of (B1) to (B3).

Preferred compounds have the structure as shown in formula (I) to (III)

| Structure | Formula | stabilizer |
|---|---|---|
| 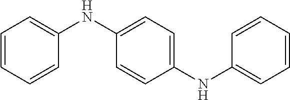 [SMILES: c1ccc(Nc2ccc(Nc3ccccc3)cc2)cc1] | (I) | (B1) |
| 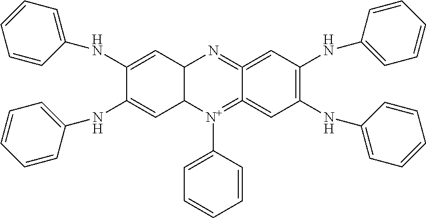 | (II) X = Cl, Br, OH | B(2) |
| 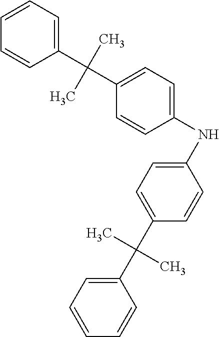 [SMILES: CC(C)(c1ccccc1)c1ccc(Nc2ccc(C(C)(C)c3ccccc3)cc2)cc1] | (III) | B(3) |

In one embodiment the secondary aryl amine may be combined with an oligomeric amine. Preferred oligomeric amine contain 0.1 to 2.0 wt.-% of at least one secondary aryl amine and/or at least one condensation product of secondary aryl amines and aliphatic aldehydes, aliphatic ketones, or mixtures thereof. This stabilizer is commercially available as Okaflex® from Oka-Tec.

Other secondary aryl amines are commercially available as Naugard® 445 (from SI Group Sales Germany (DEAB) GmbH) or Flexamin® GR (from SI Group Sales Germany (DEAB) GmbH).

The secondary aryl amine may reduce the crystallization temperature of the polyamide matrix material observed in the DSC. They are effective stabilizers against of thermal and/or hydrolytic degradation of the polyamide foam particle and polyamide particle foam molding and do not negatively influence the foam processing properties.

One example is Nigrosine (commercially available as solvent black 5, solvent black 7 or Colorant black 500) which is condensation product of aniline and nitrobenzene. An overview about the active species in nigrosine is given in U.S. Pat. No. 6,399,681 B1. Depending on the condensation conditions varies species are present in commercially available solvent black.

The invention further relates to a process for preparing polyamide foam particles as described above, comprising the steps of
a) melting a polymer mixture comprising from 5 to 99.9 wt.-% of at least one polyamide (A), from 0.1 to 5 wt.-% of at least one stabilizer (B), selected from secondary amines, from 0 to 49 wt.-% of further additives (C),
b) impregnating the melted polymer mixture with 0.01 to 4.0 wt.-% carbon dioxide, nitrogen or mixtures thereof, based on 100% of the polymer mixture, to form an impregnated polymer melt,
c) extruding and granulating the impregnated polymer melt in an underwater pelletiz-er to form polyamide foam particles.

Preferably 0.1 to 1 wt.-% of talcum or carbon black is used as further additive (C).

The invention further provides a process for preparing polyamide particle foam moldings by steam-chest molding of polyamide foam particles as described above at a temperature in the range from 100 to 170° C. and polyamide particle foam moldings obtainable according to this process.

The polyamide foam particles according to the invention are processable on standard steam chest molding equipment with steam pressure between 2-4 bar to halogen-free particle foam moldings with high thermal oxidative stability. They show high compression and tensile strength after storage for more than 500 hours at increased temperatures or increased temperatures and increased humidity.

Preferably the polyamide particle foam moldings have a density is in the range from 250 to 500 kg/m³, more preferably in the range from 300 to 400 kg/m³.

Preferably the closed cell ratio ψr of the polyamide particle foam moldings is in the range from 65 to 98, more preferably in the range from 85 to 95, determined according to DIN EN ISO 4590:2016 by volume expansion (method 2).

The polyamide particle foam moldings according to the invention may be used for reinforcement of structural parts in the automotive, aerospace and consumer industry. Further applications are for car body structures, engine parts, protective parts of BEVs or as core element for sandwich parts, especially in combination with reactive injection molding. The polyamide foam moldings may be combined with non-foamed polyamide parts for improved recyclability via one material approach.

### EXAMPLES

Hereinafter, the present invention is described in more detail and specifically with reference to the Examples, which however are not intended to limit the present invention.

### Raw Materials:

PA1: Ultramid® Flex F 38, Copolyamide 6/6.36, BASF SE, density 1060-1090 kg/m³, relative Viscosity (RV) 3.7-3.9, melting point 199° C.,
PA2: Ultramid® B40, Polyamide 6, BASF SE, density 1120-1150 kg/m³, viscosity number (VN) 240-260 ml/g, melting point 220° C.
Nu: Mirco Talc
CM: (carbon black masterbatch): Ultrabatch 420: polyamide 6 batch containing 30 wt.-% Special Black 4/beads
St1: Ultrabatch 101: polyamide 6 batch containing 15.5 w % Potassium Iodide and 4.5 Copper-(I)-iodide as stabilizer
St2: Okaflex EM from Oka-Tec (blend of polymeric amines with 4,4′-bis(a,a-dimethylbenzyl)diphenylamine as main component (stabilizer B3, formula III), bulk density 500-900 g/l, melting range >60° C.)
St3: Ultrabatch 434: Recipe: 60% ULT.B27 (PA6, RV 2,7, from BASF SE), 40% COLORANT BLACK 500 (nigrosine base; CAS101357-15-7 from Orient Chemical Industries (formula II and stabilizer type B2)
St4 Naugard 445 (4-(1-Methyl-1-phenylethyl)-N-[4-(1-methyl-1-phenylethyl)phenyl]anilin CAS-Nummer: 10081-67-1), (stabilizer B3, formula III)
St5 Irganox® 1098 (N,N′-(Hexane-1,6-diyl) bis [3-(3,5-di-tert-butyl-4-hydroxyphenyl) propanamide])

### Test Methods

### Closed Cell Ratio

The Volume fraction of closed cells and cell walls so called closed cell ratio ψr was determined via DIN EN ISO 4590-2016 by volume expansion (method 2). The measurement device that was used Accupyc 1330 is produced from micromeritics. The closed cell ratio ψr was calculated via following equation where ψr the Volume fraction of open cells was. ψr had to be calculated via equation 2. Vg corresponds to the sample volume. The sample vol-ume was measured via the geometrical sample data (3). The rough sample size was 30*30*25 mm. Vi corresponds to the sample volume of the specimen into which no air enters under test conditions and from which no gas can escape. Vi was be measured via the measurement tool Accupyc 1330.

$$\begin{matrix}ψr & = & 100 - ω r & ( 1 ) \\ ωr & = & [ ( Vg - Vi ) / Vg ] \times 100 & ( 2 ) \\ Vg & = & 2 \times [ A 1 + A 2 ) / 2 \times ( B 1 + B 2 ) / 2 \times ( C 1 + C 2 ) / 2 ] & \end{matrix}$$

### Compressive Strength was Measured at 10% Before and After Ageing

To evaluate the stability against thermal ageing, test cubes according to ISO844 were prepared from the polyamide particle foam moldings and compression strength measured at 10% compression before and after storage for 2000 hours at 120° C. and 150° C. in dry air.

### Example 1 and 2 and Comparative Examples C1-C3: Preparation of Expanded Polyamide Foam Beads and Polyamide Particle Foam Moldings

Expanded Polyamide beads were produced on a ZE40 extruder with under water granulation (UWG): throughput 60 kg/h; extruder: 200 rpm; MT270-280° C.; temperature die plate: 280-310° C., pressure melt pump before UWG: 80-95 bar; UWG: water temp. 70° C., 3000 rpm; die plate 12 holes, diameter 1 mm, water pressure of the underwater pelletizer was adjusted between 1-4 bar.

The Blowing agent (nitrogen, N2) was directly dosed into the polymer melt. All solid components were dosed into the feeding-zone of the extruder.

The obtained preformed beads are spherical with a diameter between 2-3 mm and have an initial bulk density of 280-350 g/l

The prefoamed beads were stored at least 24 h before processing. The processing of the expanded particles to a molded part, was carried out with a standard EPP chest molding machine (Erlenbach EHV-C PP 870×670) in a mold with the dimensions 200×300×25 mm. The beads were fused with cross and autoclave steam with steam pressure of 2-4 bar.

The molded parts were dried for 8 h at 80° C. (air) and then specimens with a dimension 40×40×40 mm were prepared. The specimens were stored 24 h in a standard climate (23° C./50% rel.h.) prior compression test. To evaluate the stability against thermal ageing, test cubes according to DIN EN ISO 844:2014 were stored at 120° C. and 150° C. in dry air for 2000 and measuring the compression strength at 10% compression before and after storage. Since thermal ageing leads to depolymerization also the weight loss of the samples after ageing was measured.

Examples 1 to 3 show a high heat resistance after aging as indicated by the high compressive strength after 1000 hours aging at 120° C. and a higher closed cell ratio compared with comparative Examples C1-C4.

TABLE 1
Composition and mechanical properties of Examples 1 and 2 and Comparative Examples C1-C3

| Example | C1 | C2 | C3 | C4 | 1 | 2 | 3 |
|---|---|---|---|---|---|---|---|
| PA1 | 50 | 50.0 | 50.0 | 50 | 50 | 50 | 50 |
| PA2 | 49.5 | 46.5 | 44.5 | 48.1 | 48.1 | 48.5 | 48.1 |
| N2 | 0.2 | 0.20 | 0.2 | 0.2 | 0.2 | 0.2 | 0.2 |
| Nu | 0.5 | 0.5 | 0.5 | | | | |
| CM | | 3 | 3 | 1 | 1 | | 1 |
| St1 | | — | 2 | | | | |
| St2 | | | | | 0.9 | | |
| St3 | | | | | | 1.5 | |
| St4 | | | | | | | 0.9 |
| St5 | | | | 0.9 | | | |
| Molded part density [kg/m³] | 340 | 430 | 410 | 370 | 390 | 378 | 373 |
| Compressive strength at | 6.7 MPa | 10.6 MPa | 7.0 MPa | 5.2 | 8.7 MPa | 8.5 MPa | 6.4 MPa |
| 10% before ageing | | | | | | | |
| Compressive strength at | 0 MPa | 0 MPa | 8.6 MPa | 7.8 | 9.3 MPa | 8.2 MPa | 7.0 MPa |
| 10% after 1000 h @ 120° C. | | | | | | | |
| weight loss after 2000 h @ | −17% | −13% | −6% | | −8% | −9% | |
| 150° C. | | | | | | | |
| Closed cell ratio | 90 | 86-89 | 59 | 60 | 92 | 91 | 92 |

1.-12. (canceled)

13. Polyamide foam particles comprising
(A) from 5 to 99.9 wt.-% of at least one polyamide,
(B) from 0.1 to 5 wt.-% of at least one stabilizer, selected from secondary aryl amines
(C) from 0 to 49 wt.-% of further additives,
wherein the sum of the components (A) to (C) is 100 wt.-%.

14. Polyamide foam particles according to claim 13, wherein the at least one polyamide (A) is selected from partially crystalline polyamides having a melting point in the range from 150 to 350° C., determined by differential scanning calorimetry (DSC) according to DIN EN ISO 11357-3:2018.

15. Polyamide foam particles according to claim 13, wherein the at least one polyamide (A) is selected from the group consisting of polycaprolatam (PA6), polylaurolactam (PA 12, polyhexamethylene adipamide (PA 6.6), poly-hexamethylene sebacamide (PA 6.10), polyhexamethylene dodecanamide (PA 6.12), PA 6/66, PA 66/6 and copolyamide PA6/6.36 or mixtures therefrom.

16. Polyamide foam particles according to claim 13, wherein the bulk density is in the range from 100 to 500 kg/m³.

17. Polyamide foam particles according to claim 13, wherein the at least one stabilizer (B) is selected from
(B1) an amine-containing heat stabilizer comprising bis(4-(1-methyl-1-phenylethyl)phenyl) amine, 2-ethyl-2′-ethoy-oxal anilid, dimethyl glyoxime, 2,2′-bipyridine, 1,10-phenanthroline, ortho-phenylenediamine, 1,2-diaminocyclohexane, 1,4-diamino butane, urea, 8-hydroxy quinoline, substituted urea, and combinations thereof.
(B2) a nigrosine containing stabilizer, or
(B3) a stabilizer comprising adducts of phenylenediamine with acetone, adducts of phenylenediamine with linolenic acid, 4,4′-bis(a,a-dimethylbenzyl)diphenylamine, N,N′-dinaphthyl-p-phenylenediamine, N-phenyl-N′-cyclohexyl-p-phenylenediamine,
or mixtures of two or more of (B1) to (B3).

18. A process for preparing polyamide foam particles according to claim 13, comprising the steps of
a) melting a polymer mixture comprising
from 5 to 99.9 wt.-% of at least one polyamide (A),
from 0.1 to 5 wt.-% of at least one stabilizer (B), selected from secondary aryl amines,
from 0 to 49 wt.-% of further additives (C),
b) impregnating the melted polymer mixture with 0.01 to 4.0 wt.-% carbon dioxide, nitrogen or mixtures thereof, based on 100% of the polymer mixture, to form an impregnated polymer melt,
c) extruding and granulating the impregnated polymer melt in an underwater pelletiz-er to form polyamide foam particles.

19. The process according to claim 18, wherein 0.1 to 1 wt.-% of talcum is used as further additive (C).

20. A process for preparing polyamide particle foam moldings by steam-chest molding of pol-yamide foam particles according to claim 13 at a temperature in the range from 100 to 170° C.

21. Polyamide particle foam moldings, obtainable according to the process of claim 20.

22. Polyamide particle foam moldings according to claim 21, wherein the density is in the range from 250 to 500 kg/m³.

23. Polyamide particle foam moldings according to claim 21, wherein the closed cell ratio is in the range from 65 to 98, determined according to DIN EN ISO 4590:2016.

24. Use of the polyamide particle foam moldings according to claim 21 for reinforcement of structural parts in the automotive, aerospace and consumer industry.
